(19) United States
(12) Patent Application Publication
(10) Pub. No.: US 2021/0329885 A1
(43) Pub. Date: Oct. 28, 2021

(54) Pet Bathing Brush Device

(71) Applicants: Maria Yllescas, San Bernardino, CA (US); Gabriel Yllescas, San Bernardino, CA (US)

(72) Inventors: Maria Yllescas, San Bernardino, CA (US); Gabriel Yllescas, San Bernardino, CA (US)

(21) Appl. No.: 16/855,123

(22) Filed: Apr. 22, 2020

(51) Int. Cl. A01K 13/00; A46B 11/06; A46B 15/00; B05B 1/30

(52) U.S. Cl. CPC A01K 13/001; A46B 11/066; A46B 2200/1093; B05B 1/30; A46B 15/0087

(57) ABSTRACT

A pet bathing brush device for use in bathing an animal includes a shell that defines an interior space. A pipe is coupled to and extends from a first end of the shell and is in fluidic communication with the interior space. The pipe is engageable to a water inlet hose to allow water to flow into the interior space. A plurality of tubes is coupled to and extends from a second end of the shell. The tubes are open ended and in fluidic communication with the interior space. The tubes are used to comb hair of an animal while directing the water onto the hair and skin. A panel is coupled to the shell and defines a reservoir within the interior space. A liquid soap solution can be positioned in the reservoir and selectively dispensed into the water flowing through the interior space to lather the animal.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to brush devices and more particularly pertains to a new brush device for use in bathing an animal.

### (2) Description of Related Art Including Information Disclosed Under 37 CFR 1.97 and 1.98

The prior art relates to brush device. Prior art brush devices may comprise a brush head that is engaged to a soap introduction means. The brush head may have holes positioned therein, and through which soap and water may flow. Other prior art brushes may comprise brush heads having a plurality of tubes coupled thereto through which water can flow.

### BRIEF SUMMARY OF THE INVENTION

An embodiment of the disclosure meets the needs presented above by generally comprising a shell that defines an interior space. A pipe is coupled to and extends from a first end of the shell. The pipe is in fluidic communication with the interior space. The pipe is configured to engage a water inlet hose and thus for water to flow into the interior space.

A plurality of tubes is coupled to and extends from a second end of the shell. The tubes are open ended so that the tubes are in fluidic communication with the interior space. The tubes are configured to comb hair of an animal and to direct the water onto the hair and skin of the animal.

A panel is coupled to the shell and defines a reservoir within the interior space. The reservoir is configured to position a liquid soap solution, and to selectively dispense the liquid soap solution into the water that is flowing through the interior space, to lather the animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a pet bathing brush device according to an embodiment of the disclosure.

FIG. 2 is a bottom isometric perspective view of an embodiment of the disclosure.

FIG. 3 is a bottom view of an embodiment of the disclosure.

FIG. 4 is an in use view of an embodiment of the disclosure.

FIG. 5 is a cross-sectional view of an embodiment of the disclosure.

### DETAILED DESCRIPTION OF THE INVENTION

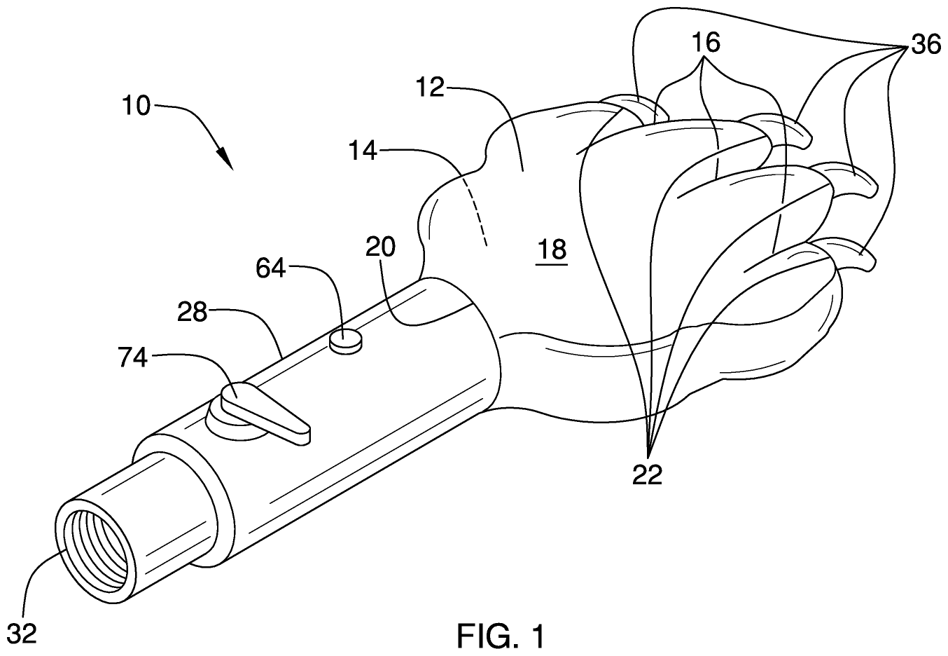

With reference now to the drawings, and in particular to FIGS. 1 through 5 thereof, a new brush device embodying the principles and concepts of an embodiment of the disclosure and generally designated by the reference numeral 10 will be described.

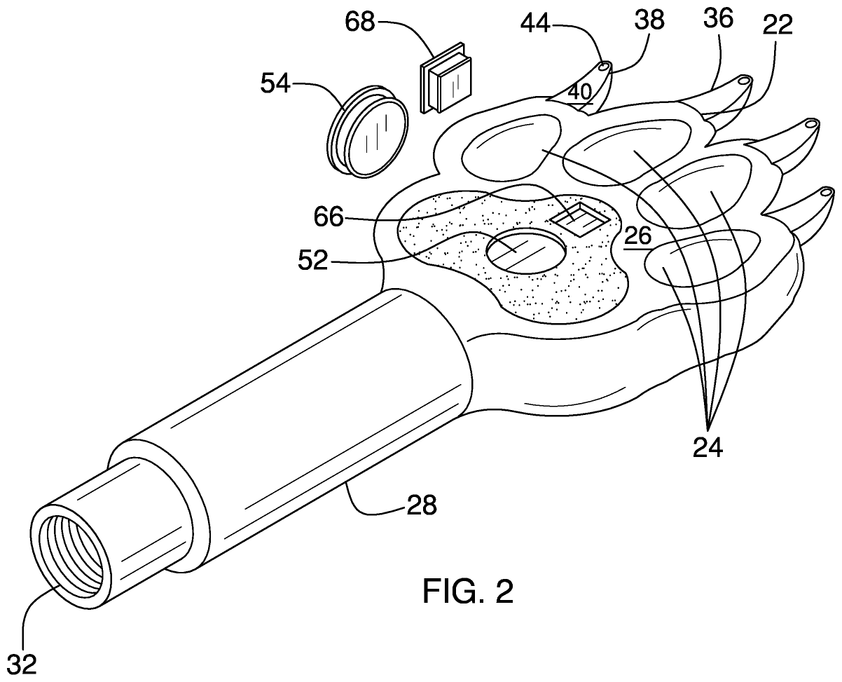

As best illustrated in FIGS. 1 through 5, the pet bathing brush device 10 generally comprises a shell 12 that defines an interior space 14. The shell 12 has a plurality of indentations 16 extending into an upper face 18 thereof, as shown in FIG. 1. Each indention 16 extends from a second end 22 toward a first end 20 of the shell 12 of the shell 12 so that the upper face 18 of the shell 12 mimics a paw. A plurality of protuberances 24 extends from a lower face 26 of the shell 12, as shown in FIG. 2, and mimics pads of a paw.

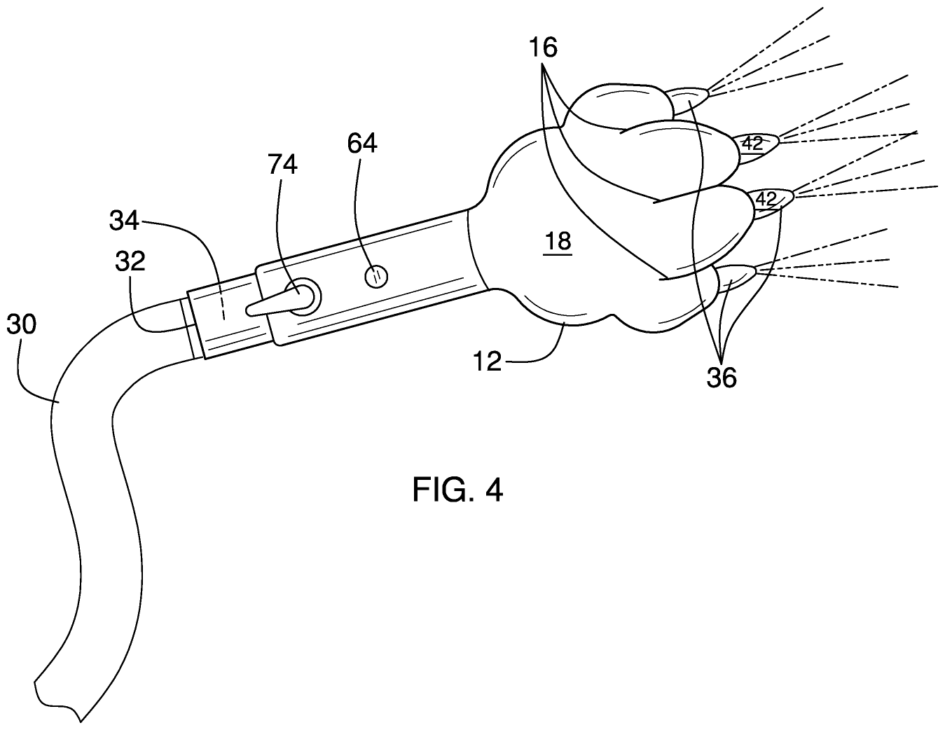

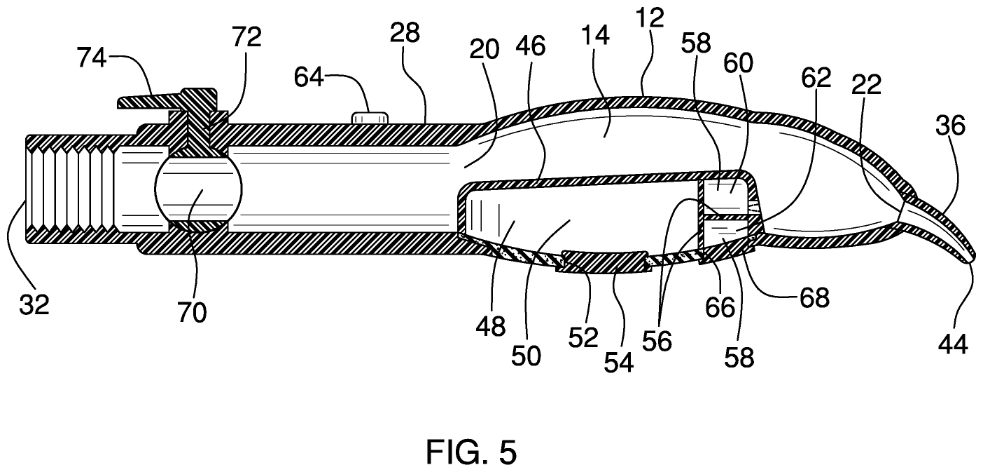

A pipe 28 is coupled to and extends from the first end 20 of the shell 12. The pipe 28 is in fluidic communication with the interior space 14, as shown in FIG. 5. The pipe 28 is configured to engage a water inlet hose 30, as shown in FIG. 4, and thus for water to flow into the interior space 14. The pipe 28 has a terminus 32 distal from the shell 12. The pipe 28 is internally threaded proximate to the terminus 32, as shown in FIG. 5, and thus is configured to threadedly couple to a female end 34 of the water inlet hose 30.

A plurality of tubes 36 is coupled to and extends from the second end 22 of the shell 12. The tubes 36 are open ended and are in fluidic communication with the interior space 14. The tubes 36 are configured to comb hair of an animal and to direct the water onto the hair and skin of the animal. The tubes 36 also can be used to massage the animal while it is being bathed.

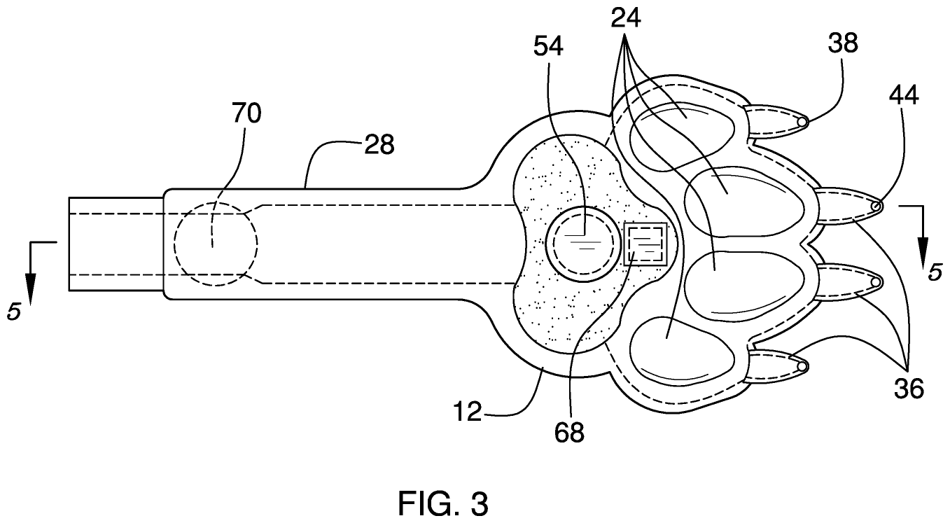

Each tube 36 tapers from the shell 12 to a limit 38 of the tube 36 that is distal from the shell 12. The tube 36 has a lower surface 40 and an upper surface 42. The lower surface 40 is substantially planar, and the upper surface 42 is arcuate, as shown in FIG. 2, so that the tube 36 mimics a claw extending from a paw. An opening 44 of the tube 36 is positioned in the lower surface 40 proximate to the limit 38 of the tube 36, as shown in FIG. 3.

A panel 46 is coupled to the shell 12 and defines a reservoir 48 within the interior space 14, as shown in FIG. 5. The reservoir 48 is configured to position a liquid soap solution 50, and to selectively dispense the liquid soap solution 50 into the water that is flowing through the interior space 14, to lather the animal.

The shell 12 has an orifice 52 positioned therein, which opens into the reservoir 48. The orifice 52 is configured for addition of the liquid soap solution 50 to the reservoir 48. A cap 54 is selectively couplable to the shell 12 to close the orifice 52.

A wall 56 is coupled to the shell 12 to define a chamber 58 within the interior space 14. A pump 60 and a battery 62 are positioned in the chamber 58. The pump 60 is operationally coupled to the reservoir 48 and the battery 62. The pump 60 is configured to pump the liquid soap solution 50 from the reservoir 48 into the water flowing through the interior space 14, to lather the animal.

A switch 64 is engaged to the pipe 28 and operationally coupled to the pump 60 and the battery 62. The switch 64 is configured to be switched to selectively couple the pump 60 to the battery 62 to power the pump 60.

The shell 12 has a cutout 66 positioned therein, which opens into the chamber 58. The cutout 66 is configured to allow access to the chamber 58 for replacement of the battery 62. A lid 68 is selectively couplable to the shell 12 to close the cutout 66. The present invention also anticipates the battery 62 being rechargeable by means of a port (not shown), which is coupled to the shell 12, operationally coupled to the battery 62, and configured to be couplable to a charging cord (not shown) to charge the battery 62.

A valve 70 is positioned in the pipe 28 and is configured to selectively control the flow of the water through the pipe 28. A stem 72 of the valve 70 is operationally engaged to a handle 74 that is positioned externally to the pipe 28. The handle 74 is configured to be turned to control the flow of the water through the pipe 28.

In use, the liquid soap solution 50 is positioned in the reservoir 48 and the pipe 28 is coupled to the water inlet hose 30. After turning on a water supply to the water inlet hose 30, a user can utilize the handle 74 to initiate and control flow of water through the tubes 36 onto the animal being bathed. As needed, the switch 64 is used to actuate the pump 60 to dispense the liquid soap solution 50 into the water flowing through the interior space 14 to lather the animal. The device 10 allows the user to wet and lather the animal using a single hand, and to massage the animal without using fingers of the hand. The tubes 36 direct the water onto the animal, while the valve 70 allows for flow optimization and easy stoppage of flow, thereby reducing wastage of water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A pet bathing brush device comprising:
a shell defining an interior space;
a pipe coupled to and extending from a first end of the shell such that the pipe is in fluidic communication with the interior space, the pipe being configured for engaging a water inlet hose, wherein the pipe is configured for flowing of water into the interior space;
a plurality of tubes coupled to and extending from a second end of the shell, the tubes being open ended such that the tubes are in fluidic communication with the interior space, wherein the tubes are configured for combing hair of an animal and for directing the water onto the hair and skin of the animal; and
a panel coupled to the shell defining a reservoir within the interior space, the reservoir being configured for positioning a liquid soap solution and for selectively dispensing the liquid soap solution into the water flowing through the interior space for lathering the animal.

2. The pet bathing brush device of claim 1, wherein the pipe has a terminus distal from the shell, the pipe being internally threaded proximate to the terminus, wherein the pipe is configured for threadedly coupling to a female end of the water inlet hose.

3. The pet bathing brush device of claim 1, further including:
the shell having a plurality of indentations extending into an upper face thereof, each indention extending from the second end of the shell toward the first end of the shell such that the upper face of the shell mimics a paw;
a plurality of protuberances extending from a lower face of the shell such that the protuberances mimic pads of a paw; and
each tube tapering from the shell to a limit of the tube distal from the shell, the tube having a lower surface and an upper surface, the lower surface being substantially planar and the upper surface being arcuate such that the tube mimics a claw extending from a paw.

4. The pet bathing brush device of claim 3, wherein an opening of the tube is positioned in the lower surface proximate to the limit of the tube.

5. The pet bathing brush device of claim 1, further including:
the shell having an orifice positioned therein and opening into the reservoir, wherein the orifice is configured for addition of the liquid soap solution to the reservoir; and
a cap selectively couplable to the shell for closing the orifice.

6. The pet bathing brush device of claim 1, further including:
a wall coupled to the shell defining a chamber within the interior space;
a pump positioned in the chamber and operationally coupled to the reservoir, wherein the pump is configured for pumping the liquid soap solution from the reservoir into the water flowing through the interior space for lathering the animal;
a battery positioned in the chamber and operationally coupled to the pump; and
a switch engaged to the pipe and operationally coupled to the pump and the battery, wherein the switch is configured for switching for selectively coupling the pump to the battery for powering the pump.

7. The pet bathing brush device of claim 6, further including:
the shell a cutout positioned therein and opening into the chamber, wherein the cutout is configured for accessing the chamber for replacing the battery; and
a lid selectively couplable to the shell for closing the cutout.

8. The pet bathing brush device of claim 1, further including a valve positioned in the pipe and being configured for selectively controlling the flow of the water through the pipe.

9. The pet bathing brush device of claim 8, wherein a stem of the valve is operationally engaged to a handle positioned externally to the pipe, wherein the handle is configured for turning for controlling the flow of the water through the pipe.

10. A water inlet hose, liquid soap solution, and pet bathing brush assembly comprising:
a water inlet hose configured to be fluidically coupled to a pressurized water supply;
a shell defining an interior space;
a pipe coupled to and extending between a first end of the shell and the water inlet hose, the pipe being in fluidic communication with the interior space;
wherein the pipe is configured for flowing of water into the interior space;
a plurality of tubes coupled to and extending from a second end of the shell, the tubes being open ended such that the tubes are in fluidic communication with the interior space, wherein the tubes are configured for combing hair of an animal and for directing the water onto the hair and skin of the animal;
a panel coupled to the shell defining a reservoir within the interior space; and
a liquid soap solution positioned in the reservoir, the reservoir being configured for selectively dispensing the liquid soap solution into the water flowing through the interior space for lathering the animal.

11. The water inlet hose, liquid soap solution, and pet bathing brush assembly claim 10, further including:
the shell having a plurality of indentations extending into an upper face thereof, each indention extending from the second end of the shell toward the first end of the shell such that the upper face of the shell mimics a paw;
a plurality of protuberances extending from a lower face of the shell such that the protuberances mimic pads of a paw; and
each tube tapering from the shell to a limit of the tube distal from the shell, the tube having a lower surface and an upper surface, the lower surface being substantially planar and the upper surface being arcuate such that the tube mimics a claw extending from a paw.

12. The water inlet hose, liquid soap solution, and pet bathing brush assembly of claim 11, wherein an opening of the tube is positioned in the lower surface proximate to the limit of the tube.

13. The water inlet hose, liquid soap solution, and pet bathing brush assembly of claim 10, further including:
the shell having an orifice positioned therein and opening into the reservoir, wherein the orifice is configured for addition of the liquid soap solution to the reservoir; and
a cap selectively couplable to the shell for closing the orifice.

14. The water inlet hose, liquid soap solution, and pet bathing brush assembly of claim 10, further including:
a wall coupled to the shell defining a chamber within the interior space;
a pump positioned in the chamber and operationally coupled to the reservoir, wherein the pump is configured for pumping the liquid soap solution from the reservoir into the water flowing through the interior space for lathering the animal;
a battery positioned in the chamber and operationally coupled to the pump; and
a switch engaged to the pipe and operationally coupled to the pump and the battery, wherein the switch is configured for switching for selectively coupling the pump to the battery for powering the pump.

15. The water inlet hose, liquid soap solution, and pet bathing brush assembly of claim 14, further including:
the shell a cutout positioned therein and opening into the chamber, wherein the cutout is configured for accessing the chamber for replacing the battery; and
a lid selectively couplable to the shell for closing the cutout.

16. The water inlet hose, liquid soap solution, and pet bathing brush assembly of claim 10, further including a valve positioned in the pipe and being configured for selectively controlling the flow of the water through the pipe.

17. The water inlet hose, liquid soap solution, and pet bathing brush assembly of claim 16, wherein a stem of the valve is operationally engaged to a handle positioned externally to the pipe, wherein the handle is configured for turning for controlling the flow of the water through the pipe.

18. A pet bathing brush device comprising:
a shell defining an interior space, the shell having a plurality of indentations extending into an upper face thereof, each indention extending from a second end of the shell toward a first end of the shell such that the upper face of the shell mimics a paw;
a plurality of protuberances extending from a lower face of the shell such that the protuberances mimic pads of a paw;
a pipe coupled to and extending from the first end of the shell such that the pipe is in fluidic communication with the interior space, the pipe being configured for engaging a water inlet hose, wherein the pipe is configured for flowing of water into the interior space, the pipe having a terminus distal from the shell, the pipe being internally threaded proximate to the terminus wherein the pipe is configured for threadedly coupling to a female end of the water inlet hose;
a plurality of tubes coupled to and extending from the second end of the shell, the tubes being open ended such that the tubes are in fluidic communication with the interior space, wherein the tubes are configured for combing hair of an animal and for directing the water onto the hair and skin of the animal, each tube tapering from the shell to a limit of the tube distal from the shell, the tube having a lower surface and an upper surface, the lower surface being substantially planar and the upper surface being arcuate such that the tube mimics a claw extending from a paw, an opening of the tube being positioned in the lower surface proximate to the limit of the tube;
a panel coupled to the shell defining a reservoir within the interior space, the reservoir being configured for positioning a liquid soap solution and for selectively dispensing the liquid soap solution into the water flowing through the interior space for lathering the animal;
the shell having an orifice positioned therein and opening into the reservoir, wherein the orifice is configured for addition of the liquid soap solution to the reservoir;
a cap selectively couplable to the shell for closing the orifice;
a wall coupled to the shell defining a chamber within the interior space;
a pump positioned in the chamber and operationally coupled to the reservoir, wherein the pump is configured for pumping the liquid soap solution from the reservoir into the water flowing through the interior space for lathering the animal;
a battery positioned in the chamber and operationally coupled to the pump;
a switch engaged to the pipe and operationally coupled to the pump and the battery, wherein the switch is configured for switching for selectively coupling the pump to the battery for powering the pump;
the shell a cutout positioned therein and opening into the chamber, wherein the cutout is configured for accessing the chamber for replacing the battery;
a lid selectively couplable to the shell for closing the cutout; and
a valve positioned in the pipe and being configured for selectively controlling the flow of the water through the pipe, a stem of the valve being operationally engaged to a handle positioned externally to the pipe, wherein the handle is configured for turning for controlling the flow of the water through the pipe.
